(19) United States
(12) Patent Application Publication
(10) Pub. No.: US 2013/0177883 A1
(43) Pub. Date: Jul. 11, 2013

(54) Systems and Methods for Directing Brain Activity

(71) Applicant: Axio, Inc., Leeds, MA (US)

(72) Inventors: Arye Zalta Barnehama, Leeds, MA (US); Laura Michelle Berman, Phoenix, AZ (US)

(73) Assignee: Axio, Inc., Leeds, MA (US)

(21) Appl. No.: 13/739,301

(22) Filed: Jan. 11, 2013

Related U.S. Application Data
(60) Provisional application No. 61/585,423, filed on Jan. 11, 2012.
(60) Provisional application No. 61/644,728, filed on May 9, 2012.

(51) Int. Cl. G09B 5/00

(52) U.S. Cl. CPC G09B 5/00
USPC 434/236

(57) ABSTRACT

Methods and devices are provided for monitoring and manipulating a person's brainwaves to achieve a desired mental state. A method of improving a student's test-taking ability includes analyzing EEG data to determine a student's focus level during an exam and providing a suggestion to the student for improving the student's focus level. A method of manipulating brain activity includes measuring a listener's brainwave frequency and providing binaural beats to the listener to guide the listener to a desired mental state. The binaural beats may be incorporated into music in such a way that they may not be distinguished over the music. A portable apparatus includes EEG electrodes connected to earphones with malleable wire that facilitates preferential placement and stability on a user's scalp.

### CROSS-REFERENCE TO RELATED APPLICATION

This application claims priority to and the benefit of, and incorporates herein by reference in its entirety, U.S. Provisional Patent Application No. 61/585,423, which was filed on Jan. 11, 2012, and U.S. Provisional Patent Application No. 61/644,728, which was filed on May 9, 2012.

### TECHNICAL FIELD

The present invention relates generally to methods and apparatus for controlling brainwave frequencies, and more particularly, to modification of the state of being of the human brain by use of an audio signal.

### BACKGROUND

The living brain exhibits electrical activity, which varies in strength and frequency over time and from one part of the brain to another. Different frequencies are associated with different moods, changing abilities, and different states of wakefulness. A brainwave frequency of 13 to 39 hertz is known as “beta-rhythm” and is normally associated with daily activity when all five sensory organs are functioning. A brainwave frequency of 8 to 13 hertz is known as “alpha-rhythm” and is often associated with a relaxed, creative state. Brainwave frequencies of 4 to 8 hertz and 0.5 to 4 hertz are known as “theta-rhythm” and “delta-rhythm” respectively. Theta-rhythm is often found in adolescents with learning disorders, and delta-rhythm is typical of normal sleep.

One of the first methods for scanning brain activity, the electroencephalograph (“EEG”), is still widely used for non-invasively monitoring human brain activity. An EEG records electrical signals from the brain through the use of electrodes connected to the subject's scalp, typically placed on the head in a standard “ten-twenty” configuration. These electrodes pick up electric signals naturally produced by the brain and transmit the signals to galvanometers (e.g., an ampere meter) that are in turn hooked up to pens, under which graph paper moves continuously. The pens trace the signals onto the graph paper. Modern EEG equipment now uses electronics, such as a computer, to store the electrical signals instead of or in addition to paper-based methods.

In general, EEGs allow researchers to follow electrical impulses across the surface of the brain and observe changes over small increments of time. An EEG can indicate the “mental state” that a person is in (e.g., asleep, awake, anaesthetized, etc.), based on characteristic current patterns of each state.

The electrical activity, or EEG, of human brains has traditionally been used as a diagnostic marker for abnormal brain function and related symptomatic dysfunction. Often, traumatic disturbances such as mechanical injury, social stress, emotional stress and chemical exposure cause neurophysiological changes that will manifest as EEG abnormalities. Disruption of this abnormal EEG activity, however, by the application of external electrical energy, referred to as a neuro-stimulation signal, may cause yet further neurophysiological changes in traumatically disturbed brain tissues, as evidenced in an amelioration of the EEG activity, and may be beneficial to an individual. Such therapeutic intervention has proven useful in pain therapy and in treating a number of non-painful neurological deficits such as depression, attention deficit disorder, and many others.

Different approaches have been taken with the goal of varying or controlling a person's brain state. For example, various audio systems are commercially sold that utilize subliminal messages to coax the brain into a different state. Known brain state inducing techniques include the use of audio signals infused with pleasing and harmonious sounds or vibrations, fixed frequency signals that are varied cyclically with respect to amplitude, and repetitive sounds such as the sound of ocean waves or rain falling on a roof. Therefore, the need and desire is very strong, and there has been a great search, for techniques and external stimuli that can vary or control the brain state.

There is a need for improved devices and methods for controlling or manipulating the brainwaves of a person. In particular, needs exist for devices and methods that improve a person's ability to achieve a desired mental state (e.g., focus), so that the person may perform better in a wide variety of tasks.

### SUMMARY OF THE INVENTION

In general, embodiments of the present invention feature methods and devices for monitoring and manipulating a person's brainwaves to achieve a desired mental state for the person, such as improved focus or relaxation. For example, the devices and methods may be used to improve the person's ability to focus while studying for and/or taking an exam. In various embodiments, the methods and devices utilize binaural beats to adjust or guide the person's brainwaves to the desired mental state. The binaural beats may be incorporated into music or other audio content provided by or received by the person. In one implementation, a device includes a pair of earphones (e.g., earbuds) connected to one or more EEG sensors. The earphones provide binaural beats to the person while the EEG sensors monitor the person's brainwaves in response to the binaural beats. Advantageously, the devices and methods may be portable and are suitable for use in any environment and location where the user's mental state may be enhanced or monitored.

In one aspect, embodiments of the invention relate to a method of improving a student's test-taking ability. The method includes the steps of: receiving EEG data from the student while the student is taking an exam; analyzing the EEG data to determine a focus level of the student during the exam; correlating the focus level of the student with a score the student received on the exam; receiving lifestyle data from the student, the lifestyle data describing an activity (e.g., sleeping, eating, resting, and exercising) the student performed prior to the exam; and providing the student with feedback that includes at least one suggestion for improving the student's focus level.

The exam may be, for example, a practice exam for an SAT exam, an AP exam, an ACT exam, a GRE exam, an MCAT exam, or an LSAT exam. The focus level may be correlated with a score the student received on a question from the exam and/or with a difficulty level of a question from the exam.

In another aspect, the invention relates to a method of manipulating brain activity. The method includes the steps of: (i) filling a buffer with a portion of a song to be played to a listener; (ii) determining a characteristic frequency f_{c} of the portion of the song; (iii) measuring a brainwave frequency of the listener; (iv) comparing the brainwave frequency of the listener with a target frequency associated with a desired listener state; (v) determining a binaural beat frequency based on the brainwave frequency of the listener and the target frequency; (vi) playing the portion of the song for the listener; (vii) providing a first frequency f₁ to a first ear of the listener; and (viii) providing a second frequency f₂ to a second ear of the listener. In general, the binaural beat frequency is determined to guide the listener to the desired listener state. A difference between the first frequency f₁ and the second frequency f₂ is equal to the binaural beat frequency, and an average of the first frequency f₁ and the second frequency f₂ is substantially equal to the characteristic frequency f_{c} of the portion of the song.

In certain embodiments, the characteristic frequency f_{c} corresponds to a musical tone (e.g., a note or chord) within the portion of the song. The binaural beat frequency may follow a stepwise function, for example, as the listener's brainwave frequency changes over time. In one embodiment, the portion of the song is stored in the buffer before it is played for the listener. The song may be received, for example, from a music streaming service and/or from the listener (e.g., the listener's own music content). The characteristic frequency f_{c}, the first frequency f₁, and/or the second frequency f₂ may be time-dependent. For example, the first frequency f₁ and the second frequency f₂ change in response to a change in the characteristic frequency f_{c}. Steps (i) through (viii) may be repeated for one or more subsequent portions of the song.

In another aspect, the invention relates to a portable apparatus for manipulating brain activity. The apparatus includes: a set of earphones (e.g., earbuds) for delivering binaural beats to a user; an EEG electrode (e.g., a dry sensor EEG electrode) for detecting a brainwave of the user; and a brainwave detection device in electrical communication with the EEG electrode. The brainwave detection device is configured to: (i) measure a brainwave frequency of the user; (ii) compare the brainwave frequency of the listener with a target frequency associated with a desired mental state; (iii) determine a binaural beat frequency based on the brainwave frequency of the user and the target frequency; and (iv) provide the binaural beat frequency to the listener. The binaural beat frequency is determined to guide the use to the desired mental state. To facilitate preferential placement and stability of the EEG electrode on the user's scalp, the EEG electrode is connected to the set of earphones with malleable wire.

In certain embodiments, the apparatus includes a music player in communication with the brainwave detection device. The apparatus may include a grounding electrode in electrical communication with the EEG electrode.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a plot of frequency versus time for a brainwave and a binaural beat, in accordance with an illustrative embodiment of the invention;

FIG. 2 is a plot of frequency versus time for a brainwave, in accordance with an illustrative embodiment of the invention;

FIG. 3 is a schematic diagram of a method of integrating binaural beats into user-supplied content, in accordance with an illustrative embodiment of the invention;

FIG. 4 is a schematic front view of a device for displaying a user's brainwave data in real time, in accordance with an illustrative embodiment of the invention;

FIG. 5 is a schematic front view of a device for detecting and analyzing a user's brainwaves and providing binaural beats to the user, in accordance with an illustrative embodiment of the invention; and

FIG. 6 is a schematic block diagram of a device for manipulating brain activity, in accordance with an illustrative embodiment of the invention.

### DETAILED DESCRIPTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

Throughout the description, where apparatus and systems are described as having, including, or comprising specific components, or where processes and methods are described as having, including, or comprising specific steps, it is contemplated that, additionally, there are apparatus and systems of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

In certain embodiments, particular beat frequencies are produced inside of the brain by supplying signals of different frequencies to each of a person's ears. This “binaural beat phenomenon” is implemented by providing an individual with signals of two different frequencies, one signal to each ear. The individual's brain detects a phase difference or differences between these signals. When these signals are naturally occurring, the detected phase difference provides directional information to the higher centers of the brain. If these signals are provided through speakers or stereo earphones, however, the phase difference is detected as an anomaly. The resulting imposition of a consistent phase difference between the incoming signals may cause the binaural beat in an amplitude modulated standing wave, within each superior olivary nucleus (sound processing center) of the brain.

In general, binaural beats may introduce auditory brainstem responses that originate in the superior olivary nucleus of each hemisphere. The binaural beats result from an interaction of two different auditory impulses, originating in opposite ears below 1000 Hz, and which differ in frequency between one and 30 Hz. For example, if a pure tone of 400 Hz is presented to the right ear and a pure tone of 410 Hz is presented simultaneously to the left ear, an amplitude modulated standing wave of 10 Hz (the difference between the two tones) is experienced as the two waveforms mesh in and out of phase within the superior olivary nuclei. This binaural beat is not heard in the ordinary sense of the word (the human range of hearing is from 20-20,000 Hz). Instead, it is perceived as an auditory beat and may be used to entrain specific neural rhythms through the frequency-following response (FFR)—the tendency for cortical potentials to entrain to or resonate at the frequency of an external stimulus. Thus, in some embodiments, a specific binaural-beat frequency is used as a consciousness management technique to entrain a specific cortical rhythm.

Various embodiments of the present invention provide systems, apparatus, and methods for using the binaural beat phenomenon to train, coax, manipulate, or otherwise influence the brain state of an individual. In one particular aspect, the invention allows an individual to enhance his or her brain's capacity to function at selected or optimal brainwave frequencies. This may be accomplished using a feedback loop in which dry-sensor, small-scale EEG electrodes are attached to the individual's scalp. The signals received at the EEG electrodes determine the optimal frequencies for customized binaural beats. Essentially, this creates a conversation between the user's brain and an audio headset. The feedback loop allows users to achieve a focused mind state quickly and then train to maintain the optimized state for a desired amount of time. Moreover, certain implementations of the invention allow users to incorporate the binaural beats into personalized music, in some cases in “real time.”

Many people are familiar with different stages of sleep (Stages 1-4 and REM sleep), where people drift in and out of varying levels of deep and light sleep. Likewise, during the day, people's minds fluctuate across many different states. The fluctuations are even greater because of the many things that come across our minds during the day (e.g., thinking about different topics, consuming caffeine, exercising, experiencing road rage, watching TV, etc.). The variety and amount of stimuli that our minds process throughout the day can become overwhelming. Similar to how the different stages of sleep affect our minds and bodies in distinct ways, our fluctuating mental states affect our abilities to do different things while we are awake. Many noticeable types of mental states exist, such as alert, focused, or sleepy, for example, all of which correlate to certain levels of performance. People want to be as productive as possible during the day, but they do not know the best way to get into their optimal productive state. It can also be difficult to recognize when they are actually in their most productive state, and the amount of distractions each day makes it difficult to stay productive.

Advantageously, various embodiments of the invention make it easier for people to find and maintain their most productive state and do so using audio and/or video content (e.g., video with an audio track). In one particular instance, a biofeedback device effects the binaural beat audio sounds on brainwaves and measures the resulting brainwaves through the use of dry electrodes. In one particular apparatus, a headset has dry electrodes that touch the scalp of the user's head. The electrodes measure the frequency of the user's brainwaves, which indicate the user's current state of mind (e.g., alert, focused, relaxed). The headset receives the measured brainwaves and uses the signals as input into a software-based algorithm to determine desired frequencies to play back to the users through headphones, creating customized binaural sounds. Those sounds, which resemble anything from music to beeps, help guide the users to the desired state of mind and keep them in that state. Not only does the headset create customized binaural beats to assist in subconscious brainwave optimization, but it also provides users with positive reinforcement when in the optimal brainwave state, reinforcement the users can consciously recognize and utilize to maintain that state.

While the mind is incredibly complex, EEG electrodes can make sense of and measure the electrical activity that stems from certain parts of the mind—in particular, activity stemming from the pre-frontal cortex. When a dry EEG electrode is placed on the scalp in front of the pre-frontal cortex (pre-frontal lobe), it measures pulses of very small electrical surges that run across the brain. The brain is composed of billions of neuronal cells that use small electrical fields to communicate. This neuronal communication produces electrical properties that may be measured by the EEG electrodes; these measurements are what compose or reveal brainwave frequencies. The frequencies encountered on the pre-frontal lobe vary from 0 Hz to 100 Hz and are commonly between about 1 Hz and about 60 Hz. Table 1 lists various classifications of brainwave frequencies and their common mental state associations.

TABLE 1
Brainwave frequencies and associated mental states.

| Frequency | | | |
|---|---|---|---|
| Range | | Name | Associated Mental State |
| >40 | Hz | Gamma waves | Higher mental activity, including perception, |
| | | | problem solving, fear, and consciousness |
| 13-39 | Hz | Beta waves | Active, busy, or anxious thinking and active |
| | | | concentration, arousal, cognition, |
| | | | and/or paranoia |
| 7-13 | Hz | Alpha waves | Relaxation (while awake), pre-sleep and |
| | | | pre-wake drowsiness, REM sleep, dreams |
| 4-7 | Hz | Theta waves | deep meditation/relaxation, NREM sleep |
| <4 | Hz | Delta waves | Deep dreamless sleep, loss of body |
| | | | awareness |

The human mind fluctuates across these ranges throughout the day. The systems and methods described herein make it easier to train a user's mind into appropriate ranges for various tasks the user must complete. Different jobs might require different states. For example, a truck driver or a military pilot might need alertness for one hour. An Olympic archer might need focus for 10 minutes. Or, a computer programmer might need focus for a few hours. Someone with insomnia might need help relaxing at night, and someone with attention deficit-hyperactivity disorder (ADHD) who cannot naturally get into the beta range might need the headset just to study. As described above, this can be accomplished using binaural beats.

In one example, if the human's brainwave is at 10 Hz (alpha state), receiving a binaural beat of 20 Hz may pull the brainwave from 10 Hz to a higher frequency. Better yet, if the human's brainwave is at 18 Hz (lower beta state), the 20 Hz binaural beat will increase the brainwave frequency even faster than if the brainwave was at 10 Hz, similar to how magnets react stronger when they are closer. In general, the closer the binaural beat frequency is to the brainwave frequency, the faster the brainwave frequency will move toward the binaural beat frequency. Accordingly, if the goal is to move the brainwave frequency quickly, it is generally preferred to provide binaural beats that are close (e.g., within about 2 Hz) to the brainwave frequency. As the brainwave frequency begins to approach the binaural beat frequency, the binaural beat frequency can be adjusted to maintain a desired difference between the brainwave frequency and the binaural beat frequency.

For example, to adjust a user's brainwave frequency from 10 Hz to 20 Hz, a binaural beat frequency of about 12 Hz may be provided to the user. As the user's brainwave frequency responds to the binaural beats and approaches 12 Hz, the binaural beat frequency may be increased to 14 Hz. As the user's brainwave frequency then approaches 14 Hz, the binaural beat frequency may be further increased, in small increments (e.g., 2 Hz increments), until the desired brainwave frequency of 20 Hz is obtained. Compared to an approach in which the binaural beat frequency is maintained at the target value (i.e., 20 Hz in this example), this approach of stepping the binaural beat frequency in small increments generally results in faster adjustment of the user's mental state.

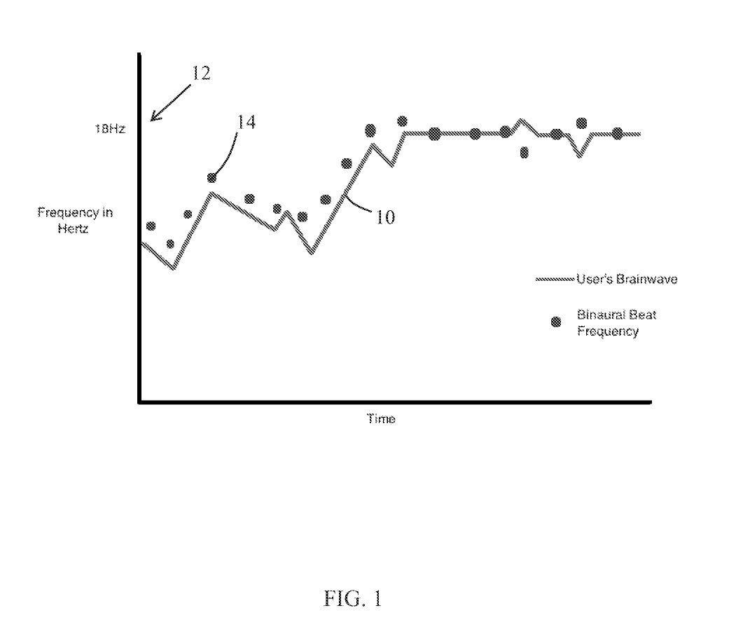

Referring to FIG. 1, in certain embodiments, to pull a brainwave frequency 10 to an optimal target frequency 12 (e.g., 18 Hz), a binaural beat frequency 14 is presented that is higher or lower than the current brainwave frequency 10, to adjust the brainwave frequency 10 upwards or downwards, as necessary. For example, when the brainwave frequency 10 is lower than the target frequency 12, a binaural beat frequency 14 is presented that is higher than the brainwave frequency 10. Likewise, when the brainwave frequency 10 is higher than the target frequency 12, a binaural beat frequency 14 is presented that is lower than the brainwave frequency 10. To maximize the rate of brainwave frequency adjustment, the binaural beat frequency 14 may be within about 8 Hz, preferably within about 4 Hz, or more preferably within about 2 Hz of the brainwave frequency.

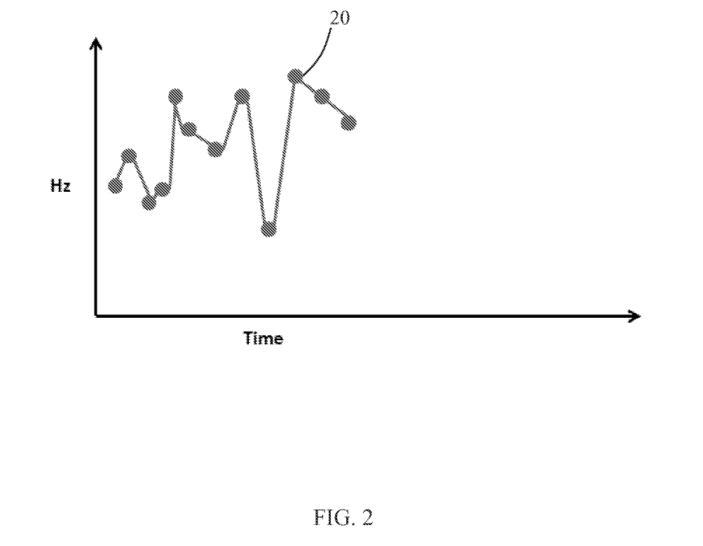

Referring to FIG. 2, a person's brainwaves 20 may fluctuate or vary considerably over time. While the actual optimization of the person's brainwaves to a certain state is not completely predictable, guidance does produce increased productivity.

The auditory tones that create the binaural beats may be “hidden” or incorporated inside music or other sounds, which the user may or may not be able to select. For example, the user may be able to select particular music or other content of interest (e.g., from an MP3 player, ITUNES®, streamed music, etc.). In other embodiments, the music is preselected, for example, according to a desired mental state to be achieved.

The potential to measure, understand, and/or utilize the electrical output of other areas of the brain may be used to increase the functionality and accuracy of the devices and methods described herein. For example, brainwaves from the hippocampus may aid users in increasing and improving memory.

In one embodiment, dry sensor, small-scale EEG electrodes are combined with binaural beats into a portable device, which is used to optimize a user's brainwaves. The device may be used, for example, to achieve an increase in focus/alertness (beta, e.g., 13-39 Hz), relaxation (alpha, e.g., 7-13 Hz), or short term memory (gamma, e.g., greater than 40 Hz). In operation, the headset delivers brainwave feedback by reading the brainwaves in user-specified frequency ranges (alpha, beta, or gamma). The raw data is then sent to a processor in the headset that, based on a stepwise function prediction, derives the binaural beat signal that is going to move the user's brainwaves closer to the optimized frequency range or target. The processor then sends the signal to an audio chip, which plays the determined binaural beat. While this is occurring, background sound (e.g., the user's own music) may be playing to give the user a pleasant auditory experience throughout. A grounding electrode may be included to allow the headset to be portable and the device to be standalone. When the EEG frequency readings indicate that the user is in the optimal frequency, the binaurals may no longer go through the stepwise function, but may work to maintain the optimal frequency.

Additionally, the device may generate signals (e.g., sound, text, video, etc.) that provide positive reinforcement to the user and inform the user about his or her brainwave state. For example, the signal may be generated to inform the user when the brainwaves have been optimized. Over time, the signals allow the user to recognize when the optimized brainwave state has been reached. The user may then eliminate doubt about the optimal brainwave state, thus eliminating a potential distraction.

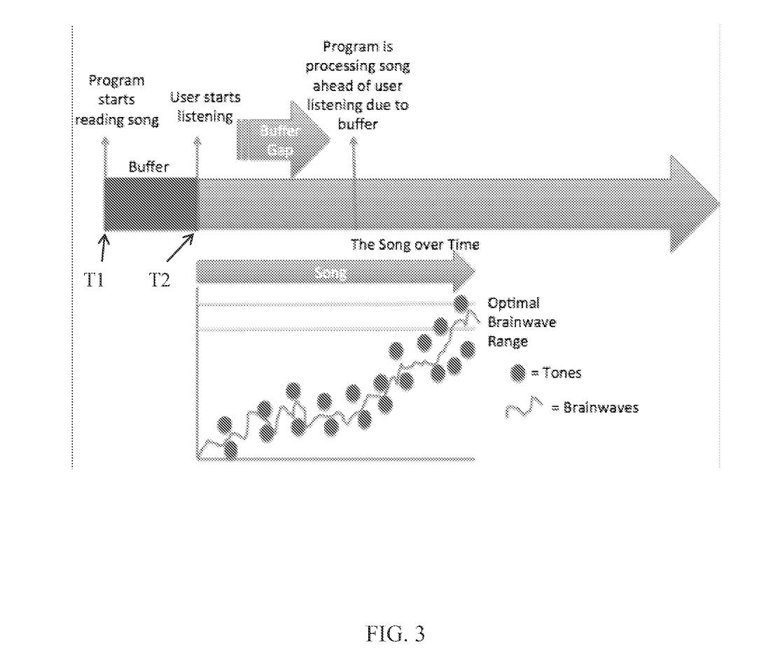

Referring to FIG. 3, in some embodiments, to integrate binaural beats into user-supplied content (e.g., music), a buffering process is used in which a song that the user has chosen or is experiencing (e.g., on a smartphone, on a computer, or from a streaming service such as PANDORA® or SPOTIFY®) is read by a microprocessor in the headset. A small sample (e.g., two seconds) of the song is stored in a memory device (e.g., flash) on the headset, such that the song is played to the user at a slight delay. During the delay the processor analyzes the tones of the song, processes the brainwave signals received from the EEG sensors, and places binaural beats into the song without causing an audible difference in the song itself. For example, if a tone (e.g., a note in a chord) that will be played in the song at time x is at 274 Hz and the next step in the user's optimization is to move from a 8 Hz mental state to a 12 Hz mental state, then the two frequencies played to the user could be at 280 Hz and 268 Hz, creating a binaural beat of 12 Hz. In this case, the average of the two frequencies is equal to the tone (i.e., 274 Hz), making it difficult or impossible for the user to differentiate the two frequencies from the tone.

In the depicted embodiment, the headset begins reading a song at an initial time T1 and the user begins hearing the song at a later time T2. By incorporating this delay between the initial time T1 and the later time T2, the device may be used to place binaural beats into user-selected content, further customizing the process of brainstate manipulation. In practice, the user may provide a playlist for a particular desired state (e.g., a sleep state) and the system may incorporate the binaural beats into each song of the playlist, based in part on the characteristics (e.g., tones) of each song.

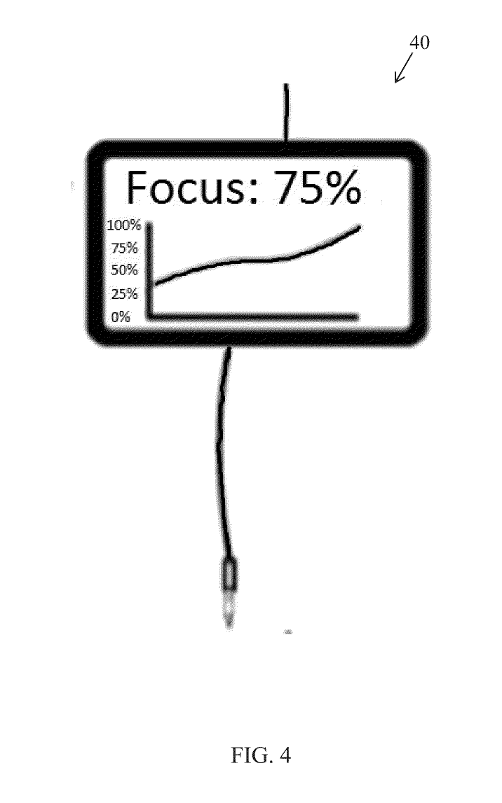

Referring to FIG. 4, in certain embodiments, the systems and devices provide various feedback mechanisms or signals that allow a user to review the results of the brainwave control process. For example, a display 40 may be provided that outputs the user's brainwave data in real time. The brainwave data may be presented as a graph and/or as an immediate “focus” level. The display 40 may be incorporated into the device itself or, in some cases, included in an application operating on a smartphone, computer, or other device. For example, the display 40 may be implemented on a smartphone that includes the binaural application and the user-supplied music.

In some embodiments, rather than or in addition to presenting a graph or numerical values, the display 40 presents a color that indicates the user's brainwave state. By presenting a color, the user may be less likely to become distracted by watching a real-time graph of focus or mental state. The display may be, for example, an LED display. In one embodiment, the display changes from red to green as the user becomes more focused, thereby informing the user that the mental state is being optimized. In other implementations, an LED bulb is provided (e.g., on a headset) that projects onto a surface, such as a desk surface. As the user is working, the user may be able to view the LEB bulb and/or the surface to determine brainwave frequency and mental state (e.g., on a focus scale), based on the color of the light. For example, a light that moves from red to orange to blue to green may inform the user about changes to a focus level while the user is working, listening to binaural beats, and/or having brainwaves monitored with an EEG headset.

In certain embodiments, the algorithm or brainwave control system for the feedback loop and binaural optimization contains or utilizes machine learning. For example, as the user listens to the music and the binaural beats work to optimize the user's brainwaves, the algorithm may change and enhance itself by determining the binaural beats that elicit the strongest response from the user's brainwaves, according to the user's brainwave state. The strength of the response may be measured in terms of how quickly a particular beat frequency (or difference between the beat frequency and the user's brainwave frequency) moves the user to the desired brain state. Thus, over time the device may become smarter and more customized for the particular user, by remembering the binaurals that are most appropriate for the user. Multiple algorithms, fine-tuned for multiple users, may be stored on a single device that is shared by more than one user.

In various implementations, a notification system is provided that informs the user about actions that can be taken to achieve a desired mental state. The notification system may monitor the user's brainwave state and focus level, either with or without binaural beats being played, to determine a “measurement” state. When the user's focus dips below a certain focus point, which may be user-defined, the notification system may deliver a notification (e.g., to a mobile device or a personal computer) to inform the user that the focus level has dropped or is otherwise inadequate. The notification may include a recommendation to the user, for example, to use the headset, get exercise, take a break, etc., to regain focus. The device may therefore monitor user focus, allow the user to set a desired minimum focus level, and, if the user's focus falls below that minimum level, notify the user and provide one or more recommendations for regaining focus.

In its initial deployment, the system's algorithm or control system settings may be based on research-based averages. Users can tailor the system, however, to fit their individual needs. For example, the headset may be worn and used to monitor a user's focus level throughout the day as the user works. The user may, if desired, take mental note of when the user felt most “in the zone” and the most productive. The user may later enter those times or highlight them in the data, and the system may adjust accordingly, based on the user's mental state during the height of his or her focus.

Referring to Table 2 below, the systems and devices may include or operate in a “training mode,” which may help a user learn how to control or adjust his or her mental state. In one embodiment, once the connectivity to each component of the system is verified, a binaural is played at an ideal mental state and at a corresponding tone, preferably the lowest possible, and a plurality of brainwave frequency measurements (e.g., 10 measurements) are taken and analyzed. Each measurement either falls into a level or not. When a measurement falls into a level, that level is store. When a measurement does not fall into a level, a zero is stored. Each level may correspond to a number of percentage points, with a maximum possible of 100% when all ten measurements are tallied up. Table 2 illustrates the levels and associated point allocations, in accordance with one embodiment. As an example, if ten measurements are in levels [6, 2, 0, 4, 4, 3, 1, 6, 5, 6 ], the corresponding percentage points for the measurements are [10, 2, 0, 6, 6, 4, 1, 10, 8, 10 ], and the percent for that measurement loop is 57%.

TABLE 2
Sample levels and associated point allocations.

| Sample Levels | Sample Ranges (Hz) | Corresponding % Points |
|---|---|---|
| 0 (not in range) | <13 or >39 | 0 |
| 1 (least focused) | 13-15 or 37-39 | 1 |
| 2 | 15-18 or 34-37 | 2 |
| 3 | 18-21 or 31-34 | 4 |
| 4 | 21-24 or 28-31 | 6 |
| 5 (very focused) | 24-25.5 or 26-28 | 8 |
| 6 (perfect focus) | 25.5-26 | 10 |

In some embodiments, binaural beats are created according to whether a brainwave frequency measurement falls into a level that is above or below an ideal mental state. For example, in a set of ten measurements, if a measurement is above the ideal state, then a counter called “above” may be increased, and if a measurement is below the ideal state, then a counter called “below” may be increased. Based on the percentage score from the ten measurements and/or whether more “above” or more “below” measurements were recorded, the next binaural beat may be created at a particular pitch, with a higher pitch corresponding to a lower percentage score. The binaural beat is intended to pull the user's mental state up (e.g., if too many “below” readings were tallied) or down (e.g., if too many “above” readings were tallied). If a user receives a percentage of 0, the process may be repeated by playing the ideal beat again. If a user scores an extremely high percentage (e.g., over 80%), then the next ten measurements may be taken in silence, without influencing beats. If the “above” and “below” tallies are identical, then a previous round of measurements may be analyzed until the “above” and “below” tallies are different. Otherwise, the process may repeat using the ideal beat.

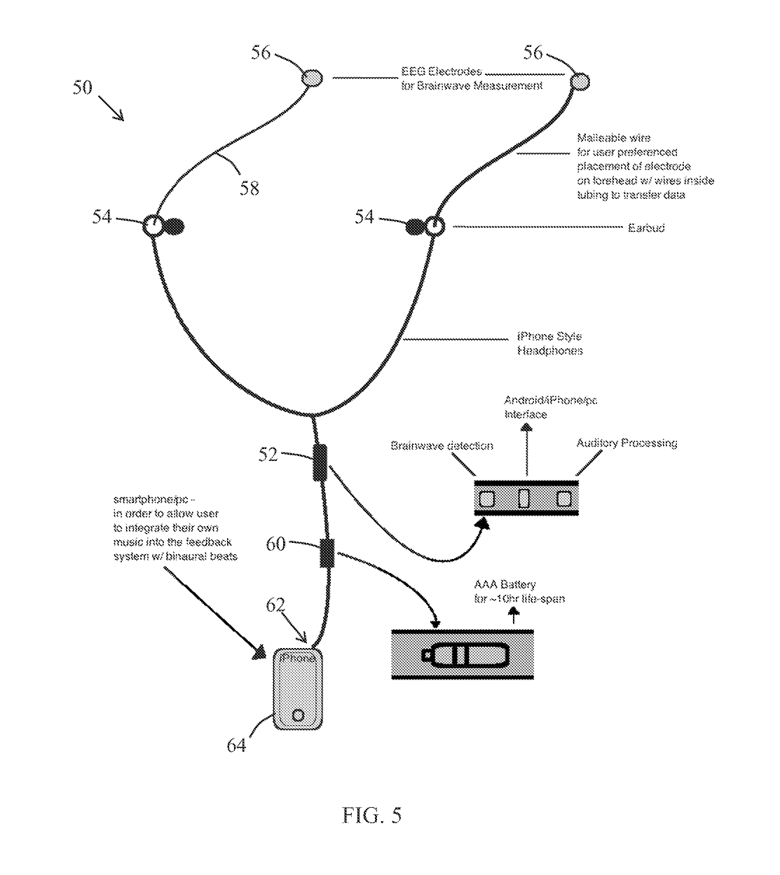

Referring to FIG. 5, in certain embodiments, a device 50 is provided for controlling a user's brainwaves by measuring the brainwaves and providing binaural beats to the user. The device 50 includes a controller 52, a pair of earphones 54 (e.g., insertable earbuds), and a pair of EEG electrodes 56. The controller 52 is in electrical communication with the earphones 54 and the EEG electrodes 56. In one embodiment, each EEG electrode 56 is connected to a corresponding earphone 54 with a malleable wire 58 that facilitates preferential placement and stability on the user's scalp. A battery pack 60 may be included to provide electrical power to the device 50. The device 50 may also include a connector 62 for connecting the device 50 to a music source 64, such as an MP3 player, a portable phone (e.g., an IPHONE), or a personal computer. In one embodiment, a wireless connection to the music source is obtained. As described herein, the device 50 is configured to measure a user's brainwaves and provide binaural beats, which may be incorporated into music or other sounds.

In certain embodiments, the systems and devices described herein are used by students to improve study habits and learning abilities. The systems and devices may include a processor that executes instructions (e.g., via software and/or online/mobile) to allow the students to monitor their mental states using EEG brainwave recording and analysis, while studying for each of their classes. In one example, students input their class schedules, from which they can select a specific class and indicate the type of work they are doing for that class (e.g., math homework, reading, taking a Spanish vocabulary practice test, etc.). A headset equipped with EEG sensors is used to monitor EEG signals at a student's command, for example, each time the student starts or stops working on a new item. The device performs analyses in real-time and in some cases it saves the data for later analysis and comparison. Advantageously, the systems and techniques described herein allow students to monitor and view data on their mental states for each class and each kind of studying that they do. The data may be analyzed to determine mental trends for specific classes and types of assignments or studying. Mental states may be cross-compared among these different categories.

The analysis and comparison of data is helpful for students to identify and understand the classes, course subjects, and assignments where they perform well, and the classes, course subjects, and assignments where they need improvement. For example, the data may inform certain students that they are unfocused while they read, but have a high level of focus when solving math problems. The device may highlight this trend and provide tips for how a student may improve focus in the weaker area. For example, the device may indicate that the student should take a break every 20 minutes while reading, but only every 45 minutes while doing math. By combining and comparing EEG data recorded from the student, the device may provide the student with comprehensive data to rank his or her focus and mental performance according to class, course subject, and/or task.

As an example, the device may help a student learn a subject (e.g., a new language, such as Spanish) by tracking the student's focus as the student is studying. The device may inform the student about how much more focused, or how much longer she stayed focused using one method of studying compared one or more other methods of studying. The device may indicate, for example, that the student focused better and 20 minutes longer when using flashcards than when reading from a textbook.

Students can also provide their results (e.g., grades) from class assignments so that mental focus (e.g., outside the classroom) may be correlated to the results and grades. With this information, the device may provide further recommendations to the students regarding how to most efficiently spend their time working on assignments and studying for each of their classes.

The systems and devices may also be used to analyze mental states while a student is taking practice questions, sections, or full exams in preparation for a standardized test, such as an SAT, AP ACT, GRE, MCAT, or LSAT exam. The systems and devices may include a software program or online and/or mobile application to perform this analysis. For tests taken on a computer, EEG data may be collected separately for each question (e.g., when only one question is displayed on the screen at a time), or it may be collected simultaneously for multiple questions (e.g., when the student can view or analyze more than one question at a time). The data may then be used to perform a full analysis of the student's mental state and focus on each question level (e.g., easy, medium, challenging), each test section, and for the overall practice exam. Also, with the scoring occurring online, instant analysis of the student's mental state and its correlation to the test performance may be given. Students may be offered advice on how to improve and/or how to use their breaks to increase focus on each section and decrease tiredness. Students may also have the option to save lifestyle data that they input for each practice section or test, such as their sleep pattern before the test, what they ate that day, and how they spent each break.

For paper tests, a timer function may be provided, and students may be able to input the type of test they are taking, and whether they are taking an entire exam or only a section (and which section). The timer function, which may be manipulated by the students (e.g., should they wish to pause the timer), will then synchronize with the EEG data from the device and record data for each section and/or full exam. All of the data may be made available to the students, and students have the ability to input their scores for all of the sections, and to correlate these scores with information about lifestyle activities (e.g., sleeping and eating habits).

In certain embodiments, the data collected by the systems and devices is transferred (e.g., wirelessly, using BLUETOOTH®) to a mobile device (e.g., a cell phone or tablet computing device) to visualize brainwaves in real-time, offer visual biofeedback, and/or record or analyze monitored brainwave data. The transfer of EEG data to mobile devices (e.g., real-time or otherwise) has important applications in neuroscience research because it greatly increases the range of activities that may be performed while instantaneously recording EEG data. The systems and devices may produce real-time feedback in visual format from the mobile device, as well as store data and update databases on how a user is performing in real-time. In one embodiment, data is uploaded to the Internet or other network to allow multiple people to view a user's brainwave status (e.g., in real-time) as the user performs a task. For example, a parent or teacher may view a child's focus level while the child is studying, or a boss could monitor an employee's focus level while the employee is working.

In certain embodiments, the systems and devices perform a preliminary “configuration” step during which a user's unique brainwave patterns are recorded and analyzed to allow subsequent neurofeedback sessions to be specifically tailored to the user. For example, the configuration step may reveal that a user's ideal mental state or brainwave frequency for focus is higher or lower than normal, or exhibits more variation than normal. In one embodiment, the systems and devices are able to analyze these unique brainwave characteristics during the configuration step, whenever a user first puts on the device. The systems and devices may then provide feedback that is optimal for that user's unique brainwave pattern.

The unique brainwave patterns of a user may be stored in memory so that the systems and devices can automatically identify the user when he or she uses the device at a later time. The systems and devices may recognize who the user is, out of several possible users who have previously used the device, based on the stored brainwave patterns obtained during the configuration step. In one embodiment, the device remembers each user and activates based on an understanding that the brainwave pattern of the current user matches a brainwave pattern stored in memory. This brainwave “fingerprinting” capability allows the device to recognize each user and provide customized neurofeedback according to the user's unique brainwave patterns. The fingerprinting capability may be used in a security setting, for example, to prevent a user from accessing another user's data stored on the device.

In some embodiments, classic neurofeedback is integrated into binaural beat, EEG-generated feedback to assist a user during a training exercise. For example, the device may provide classic auditory neurofeedback in the form of a simple tone (e.g., a beep) to the user when the user's brainwaves are in a desired state or heading towards the desired state. When the user is learning how to optimize beta waves, for example, a beep may play, as a signal of positive reinforcement, each time a desirable EEG reading is taken. This auditory neurofeedback trains the subconscious parts of the brain how to get into the desired mental state in a more efficient way. In one embodiment, by incorporating the auditory neurofeedback into the binaural beat feedback, the user is provided with multiple layers of auditory neurofeedback. The user may receive the classic neurofeedback as just described, binaural beats designed to synch the user's brainwaves into the desired state (e.g., more quickly than binaural beats not generated from EEG readings), and/or tonal changes in the binaural beats to provide an indication of whether or not the user is improving or heading in the right direction.

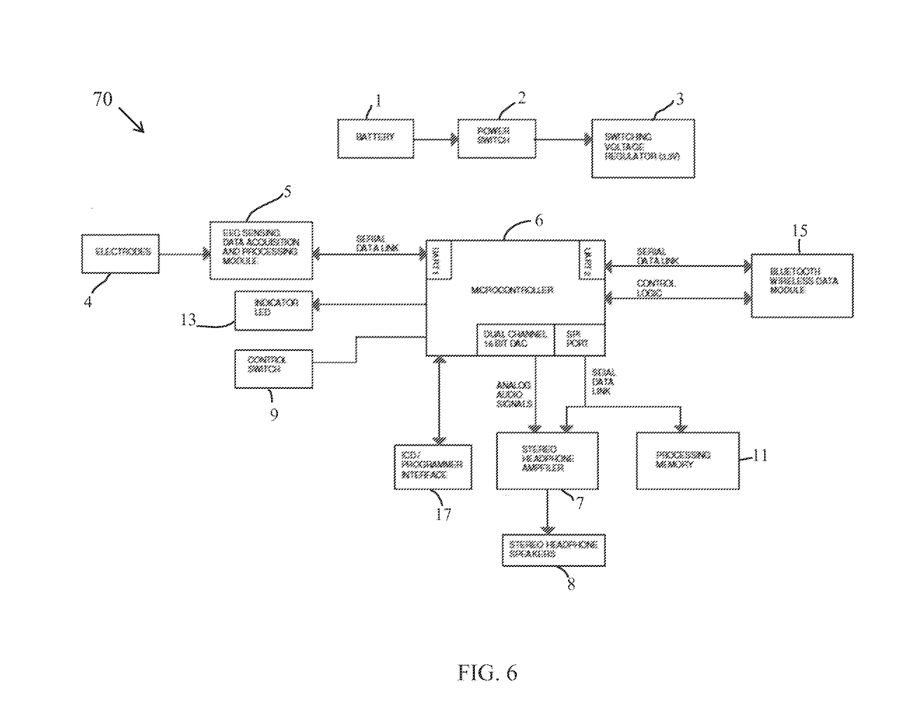

With reference to FIG. 6, in certain embodiments, a device 70 includes a power supply section comprised of a battery 1, a power switch 2, and a switching voltage regulator 3. When the switch 2 is open, no power is supplied to the device. When the switch 2 is closed, power from the battery is connected to the switching voltage regulator. The switching regulator 3 regulates the supplied battery power to 3.3 volts, and then supplies this regulated voltage as needed to circuits within the device 70.

The device also includes electrodes 4 and an EEG sensing module 5 that serve as primary measuring and processing circuits within the device. Typically, three electrodes (Signal, Reference, and Ground) are in electrical contact with selected locations on the subject being monitored. EEG potential voltages are conducted from the subject, into the electrodes, and then to the EEG sensing module. The sensing module 5 buffers and amplifies the EEG signals, then converts the signals into a digital representation of the signals. The digital data is then processed by the module 5 using digital algorithms that calculate the frequency content of the EEG signal.

Overall operation of the device 70 is controlled by a microcontroller 6. The microcontroller 6 communicates with the various modules in the system, receiving data from and/or sending data and commands to the various modules. The microcontroller 6 contains internal peripherals to facilitate communication with the modules. The peripherals may include UARTs (Universal Asynchronous Receiver/Transmitter) for standardized asynchronous serial communications, SPI (Serial Peripheral Interface) ports for synchronous master/slave serial communications, and a DAC (Digital to Analog Converter) for outputting a stereo analog audio signal.

With continued reference to FIG. 6, the EEG sensing module 5 transmits its processed EEG data to the microcontroller via a serial link connected to, for example, a UART in the microcontroller 6. The microcontroller 6 receives the data and further processes it with algorithms that calculate appropriate binaural tones as a function of the EEG frequency data. The microcontroller 6 inputs the digitally calculated binaural tones into its internal DAC. The DAC converts the digital signals into a stereo analog signal output.

The device 70 also includes an audio circuit comprised of a stereo headphone amplifier 7 and stereo headphone speakers 8. The amplifier 7 receives the stereo analog output from the DAC then amplifies the signal as appropriate for the stereo headphone speakers 8. The amplifier 7 is also connected to the microcontroller 6 with an SPI port. The microcontroller 6 transmits volume information to the amplifier 7, then the amplifier 7 adjusts its gain (and therefore the volume) according to the data sent.

The device also includes a BLUETOOTH transceiver module 15 to communicate wirelessly to a laptop, smartphone, tablet, or other external smart device. The BLUETOOTH module connects to the microcontroller 6 via a serial data link through one of the microcontroller UARTs. The microcontroller 6 can send and receive serial data to the BLUETOOTH module that in turn sends and receives the data to the external smart device. The nature of the data sent and received may be determined by the functionality of the device.

The device 70 also includes a memory module 11 for storing data. The memory module 11 is connected to a microcontroller SPI port via a serial data link. The memory module 11 can store several hundred megabytes or more of data sent to it by the microcontroller 6. The memory can then be read back by the microcontroller 6 as needed. If the memory is nonvolatile, the memory will be retained while the device is powered off. The nature of the data in memory may be determined by the functionality of the device, but will typically contain sound files for binaural tone processing. These may be predetermined and preloaded files for particular sounds to be used, or could be buffer files for processing audio data from a tune player or other music file source.

The device 70 also includes a user interface comprising of an LED 13 and a control switch 9. The LED 13 is operated by the microcontroller 6. Operation of the LED indicates an operational state of the device. LED indication may be simple, for instance an off/on indication where lit indicates device on and unlit indicates device off. Alternatively, LED operation could indicate more complex device states, by showing various blinking formats. The switch state is read by the microcontroller 6. The switch 9 is used to enter control data from the user into the microcontroller 6. The nature of the data may be determined by the functionality of the device. Data may be entered by applying different press and release sequences to the button.

Still referring to FIG. 6, the microcontroller operation may be determined by executing an instruction code contained in microcontroller program memory. The instruction code is preferably designed for particular device functionality. The designed code may then be programmed into the microcontroller program memory. A programming connector 17 is included in the device 70 as a means to program the microcontroller 6 after it is installed into the device printed circuit board.

The foregoing discussion discloses and describes merely exemplary embodiments of the present invention. As will be understood by those skilled in the art, the present invention may be embodied in other specific forms without departing from the spirit or essential characteristics thereof. Various steps and/or components as described in the figures and specification may be added or removed from the processes and system described herein, and the steps described may be performed in an alternative order, consistent with the spirit of the invention. Accordingly, the disclosure of the present invention is intended to be illustrative, but not limiting of the scope of the invention, as well as other claims. The disclosure, including any readily discernible variants of the teachings herein, define, in part, the scope of the foregoing terminology.

What is claimed is:

1. A method of improving a student's test-taking ability, the method comprising the steps of:
receiving EEG data from the student while the student is taking an exam;
analyzing the EEG data to determine a focus level of the student during the exam;
correlating the focus level of the student with a score the student received on the exam;
receiving lifestyle data from the student, the lifestyle data describing an activity the student performed prior to the exam; and
providing the student with feedback comprising at least one suggestion for improving the student's focus level.

2. The method of claim 1, wherein the exam is a practice exam for an SAT exam, an AP exam, an ACT exam, a GRE exam, an MCAT exam, or an LSAT exam.

3. The method of claim 1, wherein the focus level is correlated with a score the student received on a question from the exam.

4. The method of claim 1, wherein the focus level is correlated with a difficulty level of a question from the exam.

5. The method of claim 1, wherein the activity comprises at least one member selected from the group consisting of sleeping, eating, resting, and exercising.

6. A method of manipulating brain activity, the method comprising the steps of:
(i) filling a buffer with a portion of a song to be played to a listener;
(ii) determining a characteristic frequency f_{c} of the portion of the song;
(iii) measuring a brainwave frequency of the listener;
(iv) comparing the brainwave frequency of the listener with a target frequency associated with a desired listener state;
(v) determining a binaural beat frequency based on the brainwave frequency of the listener and the target frequency, wherein the binaural beat frequency is determined to guide the listener to the desired listener state;
(vi) playing the portion of the song for the listener;
(vii) providing a first frequency f₁ to a first ear of the listener; and
(viii) providing a second frequency f₂ to a second ear of the listener, wherein a difference between the first frequency f₁ and the second frequency f₂ is equal to the binaural beat frequency, and wherein an average of the first frequency f₁ and the second frequency f₂ is substantially equal to the characteristic frequency f_{c} of the portion of the song.

7. The method of claim 6, wherein the characteristic frequency f_{c} corresponds to a musical tone within the portion of the song.

8. The method of claim 6, wherein the binaural beat frequency follows a stepwise function.

9. The method of claim 6, wherein filling the buffer comprises storing the portion of the song in the buffer before the portion of the song is played for the listener.

10. The method of claim 6, further comprising the step of receiving the song from a music streaming service.

11. The method of claim 6, further comprising the step of receiving the song from the listener.

12. The method of claim 6, wherein the characteristic frequency f_{c}, the first frequency f₁, and the second frequency f₂ are time-dependent.

13. The method of claim 6, wherein the first frequency f₁ and the second frequency f₂ change in response to a change in the characteristic frequency f_{c}.

14. The method of claim 6, further comprising repeating steps (i) through (viii) for a subsequent portion of the song.

15. A portable apparatus for manipulating brain activity, the apparatus comprising:
a set of earphones for delivering binaural beats to a user;
an EEG electrode for detecting a brainwave of the user, the EEG electrode connected to the set of earphones with malleable wire that facilitates preferential placement and stability on the user's scalp; and
a brainwave detection device in electrical communication with the EEG electrode, the brainwave detection device configured to:
(i) measure a brainwave frequency of the user;
(ii) compare the brainwave frequency of the listener with a target frequency associated with a desired mental state;
(iii) determine a binaural beat frequency based on the brainwave frequency of the user and the target frequency; and
(iv) provide the binaural beat frequency to the listener, wherein the binaural beat frequency is determined to guide the use to the desired mental state.

16. The apparatus of claim 15, comprising a music player in communication with the brainwave detection device.

17. The apparatus of claim 15, wherein the earphones comprise earbuds.

18. The apparatus of claim 15, wherein the EEG electrode is a dry sensor EEG electrode.

19. The apparatus of claim 15, comprising a grounding electrode in electrical communication with the EEG electrode.
